(19) United States
(12) Patent Application Publication
(10) Pub. No.: US 2026/0281824 A1
(43) Pub. Date: Sep. 17, 2026

(54) PROCEDURES FOR SMD OPERATION IN WLANS

(71) Applicant: Samsung Electronics Co., Ltd., Suwon-si (KR)

(72) Inventors: Peshal Nayak, Plano, TX (US); Boon Loong Ng, Plano, TX (US); Bilal Sadiq, Plano, TX (US); Vishnu Vardhan Ratnam, Frisco, TX (US); Yue Qi, Plano, TX (US); Rubayet Shafin, Frisco, TX (US)

(21) Appl. No.: 19/555,698

(22) Filed: Mar. 3, 2026

Related U.S. Application Data
(60) Provisional application No. 63/770,105, filed on Mar. 11, 2025.
(60) Provisional application No. 63/778,145, filed on Mar. 26, 2025.
(60) Provisional application No. 63/779,916, filed on Mar. 28, 2025.
(60) Provisional application No. 63/797,521, filed on Apr. 30, 2025.

(51) Int. Cl. H04W 36/00; H04W 36/08; H04W 76/15; H04W 84/12

(52) U.S. Cl. CPC H04W 36/0016; H04W 36/08; H04W 76/15; H04W 84/12

(57) ABSTRACT

Methods and apparatuses for procedures for seamless mobility domain (SMD) in WLANS. A method performed by a current AP MLD includes receiving, from a non-AP MLD via a preparation request frame during a preparation stage of a roam procedure for the non-AP MLD to roam from the current AP MLD to a target AP MLD, information indicating one or more links to be setup with the target AP MLD. The method includes receiving, from the target AP MLD, information indicating that the one or more links has been setup, where an IEEE 802.1X controlled port of the target AP MLD is in a blocked state such that general data traffic cannot pass directly between the non-AP MLD and the target AP MLD. The method includes transmitting, to the non-AP MLD via a preparation response frame, information indicating that at least one of the indicated links has been setup.

### CROSS-REFERENCE TO RELATED APPLICATION(S) AND CLAIM OF PRIORITY

This application claims priority under 35 U.S.C. § 119 (e) to U.S. Provisional Patent Application No. 63/770,105, filed on Mar. 11, 2025, U.S. Provisional Patent Application No. 63/778,145, filed on Mar. 26, 2025, U.S. Provisional Patent Application No. 63/779,916, filed on Mar. 28, 2025, U.S. Provisional Patent Application No. 63/797,521, filed on Apr. 30, 2025, and U.S. Provisional Patent Application No. 63/969,992, filed on Jan. 28, 2026. The above identified provisional patent applications are hereby incorporated by reference in their entirety.

### TECHNICAL FIELD

This disclosure relates generally to wireless communication, and more specifically to procedures for seamless mobility domain (SMD) in wireless local area networks (WLANs) including next generation WLANs.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for SMD in WLANS.

In one embodiment, a method performed by a current access point (AP) multi-link device (MLD) includes receiving, from a non-AP MLD via a preparation request frame during a preparation stage of a roam procedure for the non-AP MLD to roam from the current AP MLD to a target AP MLD, information indicating one or more links to be setup with the target AP MLD. The, method includes receiving, from the target AP MLD, information indicating that the one or more links has been setup, where an IEEE 802.1X controlled port of the target AP MLD is in a blocked state such that general data traffic cannot pass directly between the non-AP MLD and the target AP MLD. The method includes transmitting, to the non-AP MLD via a preparation response frame, information indicating that at least one of the indicated links has been setup.

In another embodiment, a method performed by a target AP MLD includes receiving, from a current AP MLD during a preparation stage of a roam procedure for a non-AP MLD to roam from the current AP MLD to the target AP MLD, information indicating one or more links to be setup with the target AP MLD. The method includes transmitting, to the current AP MLD, information indicating that the one or more links has been setup, where an IEEE 802.1X controlled port of the target AP MLD is in a blocked state such that general data traffic cannot pass directly between the non-AP MLD and the target AP MLD. The method includes transmitting, to the current AP MLD, information indicating that at least one of the indicated links has been setup.

In yet another embodiment, a method performed by a non-AP MLD includes transmitting, to a current AP MLD via a preparation request frame during a preparation stage of a roam procedure for the non-AP MLD to roam from the current AP MLD to a target AP MLD, information indicating one or more links to be setup with the target AP MLD. The method includes receiving, from the current AP MLD via a preparation response frame, information indicating that at least one of the one or more indicated links has been setup, wherein an IEEE 802.1X controlled port of the target AP MLD is in a blocked state such that general data traffic cannot pass directly between the non-AP MLD and the target AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example port handling procedure according to embodiments of the present disclosure;

FIG. 4 illustrates another example port handling procedure according to embodiments of the present disclosure;

FIG. 5 illustrates an example timing synchronization function (TSF) sub-element format according to embodiments of the present disclosure;

FIG. 6 illustrates an example TSF element format according to embodiments of the present disclosure;

FIG. 7 illustrates another example TSF element format according to embodiments of the present disclosure;

FIG. 8 illustrates yet another example TSF element format according to embodiments of the present disclosure;

FIG. 9 illustrates an example per-link information field format according to embodiments of the present disclosure;

FIG. 10 illustrates an example candidate selection procedure with TSF information sharing according to embodiments of the present disclosure;

FIG. 11 illustrates an example of TSF sharing during a preparation phase according to embodiments of the present disclosure;

FIG. 12 illustrates an example of TSF sharing during an execution phase according to embodiments of the present disclosure;

FIG. 13 illustrates an example of TSF sharing through the target AP MLD according to embodiments of the present disclosure; and

FIG. 14 illustrates an example method performed by an AP MLD in a wireless communication system according to embodiments of the present disclosure.

### DETAILED DESCRIPTION

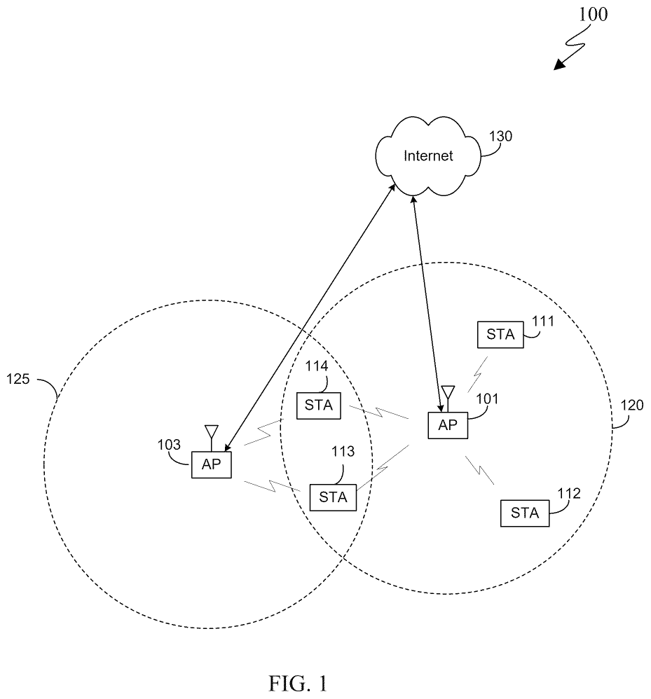

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024; [2] IEEE Std 802.11-2020; [3] IEEE P802.11bn/D1.0, 2025.

As described in [3], The goal of seamless roaming is to provide mechanisms for a non-AP MLD to transition from current AP MLD to target AP MLD such that the time during which the connection is lost is minimal. The seamless roaming procedure can enable a non-AP MLD to remain in state 4 while transitioning from current AP MLD to target AP MLD.

The roaming procedure can comprise of multiple stages. Two of the important stages are a preparation stage and roam execution/transition stage. During the preparation stage, the non-AP MLD can setup links with the target AP MLD and perform context transfer. Following this stage, the non-AP MLD can perform a roam execution/transition procedure by sending a request frame to transition from current AP MLD to target AP MLD. The current AP MLD can process the request frame and send a response frame to the non-AP MLD after the transfer of context is complete.

These procedures can enable the non-AP MLD to seamlessly roam from the current AP MLD to the target AP MLD.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating procedures for SMD in WLANS anchor link design for multi-link operation in WLANS. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

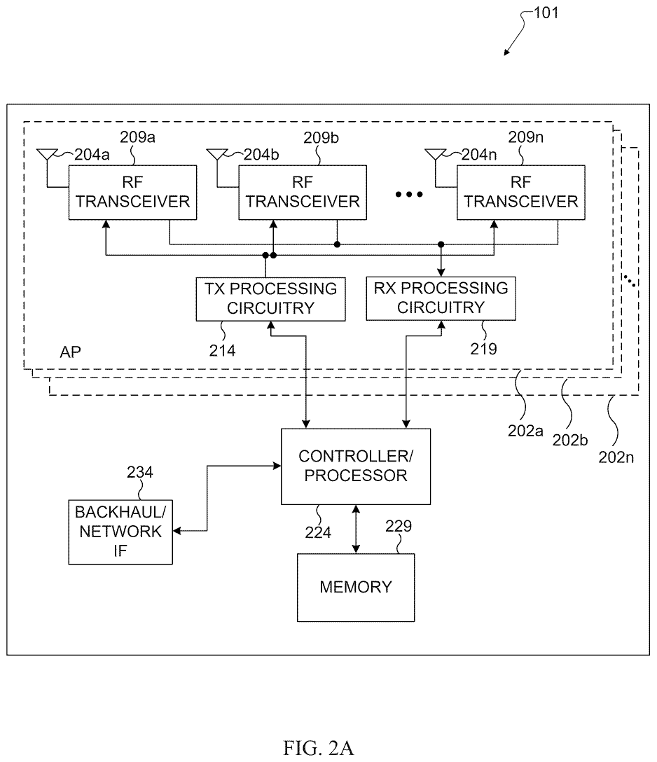

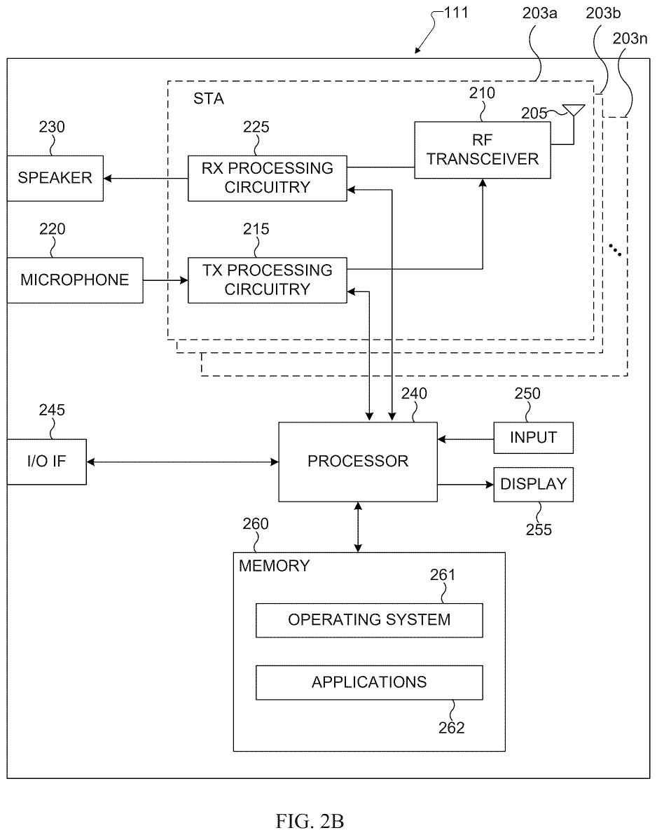

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHZ, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating procedures for SMD in WLANS. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHZ, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate procedures for SMD in WLANS. In some embodiments, the processor 240 includes at least one microprocessor or microcontroller.

The processor 240 is also capable of executing other processes and programs resident in the memory 260, such as operations for facilitating procedures for SMD in WLANS. The processor 240 can move data into or out of the memory 260 as required by an executing process. In some embodiments, the processor 240 is configured to execute a plurality of applications 262, such as applications for facilitating procedures for SMD in WLANS. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure recognize that the IEEE 802.1X Port determines when to allow data traffic across an IEEE 802.11 link. A single IEEE 802.1X Port maps to one association, and each association maps to an IEEE 802.1X Port. An IEEE 802.1X Port consists of an IEEE 802.1X Controlled Port and an IEEE 802.1X Uncontrolled Port. The IEEE 802.1X Controlled Port is blocked from passing general data traffic between two STAs until an IEEE 802.1X authentication procedure completes successfully over the IEEE 802.1X Uncontrolled Port. Once the authentication and key management (AKM) completes successfully, data protection is enabled to prevent unauthorized access, and the IEEE 802.1X Controlled Port unblocks to allow protected data traffic. IEEE 802.1X Supplicants and Authenticators exchange protocol information via the IEEE 802.1X Uncontrolled Port. It is expected that most other protocol exchanges use the IEEE 802.1X Controlled Ports. However, a given protocol might need to bypass the authorization function and make use of the IEEE 802.1X Uncontrolled Port.

Various embodiments of the present disclosure recognize that a non-AP MLD can have one or more non-AP STAs affiliated with it. The non-AP MLD is capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD BSS transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. Only one of the two data paths can be used at a time.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support, and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, SCS, MSCS, EPCS, etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

When a seamless roaming procedure is carried out, the 802.1x port behavior for the current and the target AP MLD needs to be provided. This behavior is missing in the current specification.

When a non-AP MLD performs a preparation phase, the non-AP MLD may want to have a guarantee that the links prepared at the target AP MLD will remain in the prepared state when the non-AP MLD roams from the current AP MLD to the target AP MLD. However, one or more of the target AP MLD's APs can face or have a critical event scheduled around the time when the non-AP MLD roams from the current AP MLD to the target AP MLD. E.g., one of the prepared links of the target AP MLD may go away due to a reboot, reconfiguration to STA mode to perform some measurement, etc. In such a case, the prepared link at the target AP MLD may not be available after the non-AP MLD roams to it or may have undergone link deletion.

When a non-AP MLD roams from current AP MLD to a target AP MLD, the non-AP MLD needs to synchronize its TSF timer with that of the target AP MLD. The current AP MLD and the target AP MLD's TSF may not necessarily be in synchronization with each other. As a result, the non-AP MLD needs to synchronize its TSF timer with the target AP MLD. The non-AP MLD can obtain the TSF timer of the target AP MLD through the target AP MLD directly. For instance, the non-AP MLD can obtain it via the beacon of the target AP MLD or by sending a probe request to the target AP MLD. However, this may require the non-AP MLD to wait until after its transition to the target AP MLD or go off-channel to obtain the TSF timer from the target AP MLD. Both of these may not be desired and can cause performance degradations to the non-AP MLD. An efficient method for performing TSF synchronization is needed.

Accordingly, the present disclosure provides a number of solutions for handling 802.1x port behavior during seamless roaming. Aspects include: (1) behavior during preparation phase; (2) behavior during execution phase; (3) behavior during the transient state following the receipt of a link reconfiguration response frame; (4) behavior during roaming through target AP MLD; and (6) uncontrolled port behavior.

The present disclosure further provides a number of solutions for handling a guaranteed roam in WLANs including next generation WLANs. Aspects include: (1) roam guarantee; (2) guarantee on added links; (3) at least one link availability; (4) backup links; (5) solicited guaranteed roam; (6) unsolicited guaranteed roam; and (7) capability advertisement.

The present disclosure further provides a number of solutions for handling TSF information sharing in next generation WLANs. Aspects include: (1) TSF synchronization through current AP MLD; (2) request for YSF information; (3) behavior at current AP and non-AP; (4) TSF timer handling during transient phase; (5) example signaling; and (6) example operation.

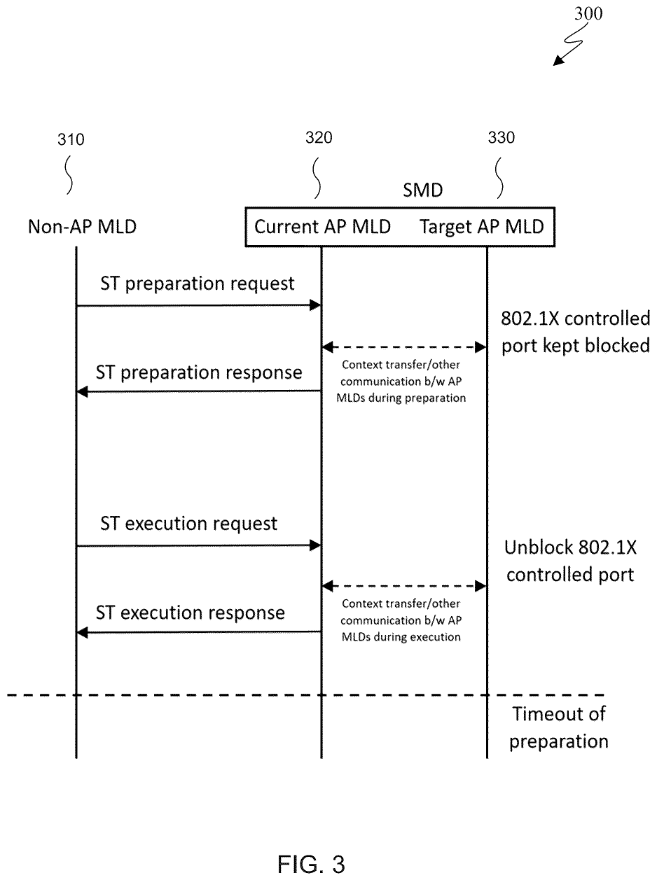

FIG. 3 illustrates an example port handling procedure 300 according to embodiments of the present disclosure. The embodiment of the example port handling procedure of FIG. 3 is for illustration only. Different embodiments of the example port handling procedure could be used without departing from the scope of this disclosure.

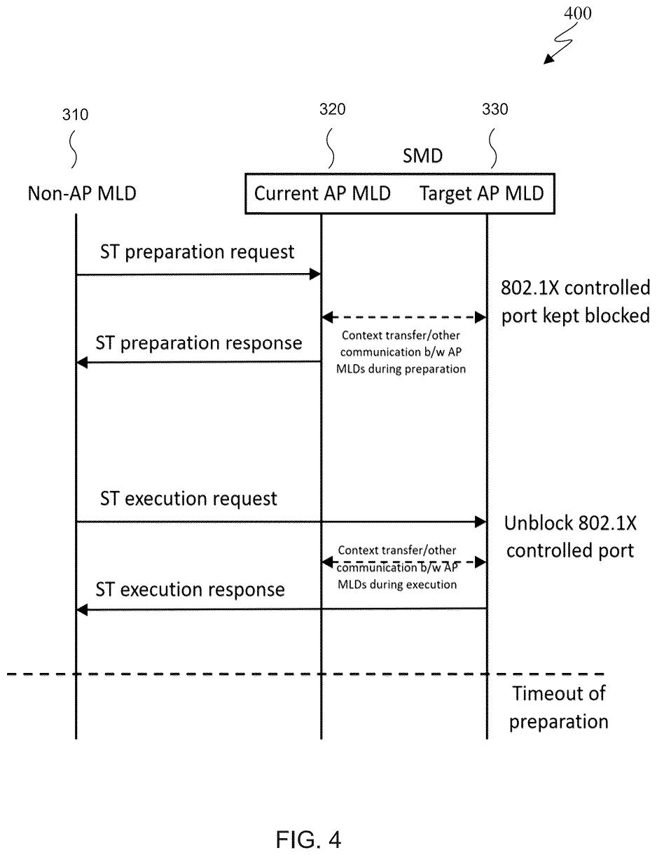

FIG. 4 illustrates another example port handling procedure 400 according to embodiments of the present disclosure. The embodiment of the example port handling procedure of FIG. 4 is for illustration only. Different embodiments of the example port handling procedure could be used without departing from the scope of this disclosure.

According to one embodiment, when the current AP MLD 320 receives a preparation request frame from the non-AP MLD 310 (e.g., a link reconfiguration request frame for preparation phase), the 802.1x controlled port for the target AP MLD 330 can be kept in a blocked state. Thus, when the links at the target AP MLD 330 are prepared, general data traffic cannot directly pass between the non-AP MLD 310 and the target AP MLD 330.

According to one embodiment, when the current AP MLD 320 transmits a preparation response frame to the non-AP MLD 310 (e.g., a link reconfiguration response frame for preparation phase), the 802.1x controlled port for the target AP MLD 330 can be kept in a blocked state. Thus, when the links at the target AP MLD 330 are prepared, general data traffic Ocannot directly pass between the non-AP MLD 310 and the target AP MLD 330.

According to one embodiment, when the current AP MLD 320 receives a preparation request frame from the non-AP MLD 310 (e.g., a link reconfiguration request frame for preparation phase), the 802.1x controlled port for the current AP MLD 320 can be kept in a unblocked state. Thus, when the links at the target AP MLD 330 are prepared, general data traffic can directly pass between the non-AP MLD 310 and the current AP MLD 320.

According to one embodiment, when the current AP MLD 320 transmits a preparation response frame to the non-AP MLD 310 (e.g., a link reconfiguration response frame for preparation phase), the 802.1x controlled port for the current AP MLD 320 can be kept in a unblocked state. Thus, when the links at the target AP MLD 330 are prepared, general data traffic can directly pass between the non-AP MLD 310 and the current AP MLD 320.

According to one embodiment, the above behavior can be done when one or more links requested by the non-AP MLD in the link reconfiguration request frame are accepted.

According to one embodiment, when an execution/transition request frame (e.g., a link reconfiguration request frame for execution/transition phase) is received from the non-AP MLD 310 within the timeout period, the 802.1x controlled port for the target AP MLD 330 can be unblocked. Thus, the general data traffic can pass between the non-AP MLD 310 and the target AP MLD 330 when possible (e.g., depending on the power save state of the added links).

According to one embodiment, when an execution/transition response frame (e.g., a link reconfiguration response frame for execution/transition phase) is transmitted by the current AP MLD 320, the 802.1x controlled port for the target AP MLD 330 can be unblocked. Thus, the general data traffic can pass between the non-AP MLD 310 and the target AP MLD 330 when possible (e.g., depending on the power save state of the added links).

According to one embodiment, when preparation and execution are completed in a single step, the 802.1x controlled port for the target AP MLD 330 can be unblocked. Thus, the general data traffic can pass between the non-AP MLD 310 and the target AP MLD 330 when possible (e.g., depending on the power save state of the added links).

According to one embodiment, when an execution/transition request frame (e.g., a link reconfiguration request frame for execution/transition phase) within the timeout period is received from the non-AP MLD 310, the 802.1x controlled port for the current AP MLD 320 can be kept in an unblocked state. Thus, general data traffic can directly pass between the non-AP MLD 310 and the current AP MLD 320 in downlink direction. For uplink direction, the data traffic can be blocked.

According to one embodiment, when an execution/transition request frame (e.g., a link reconfiguration request frame for execution/transition phase) within the timeout period is received from the non-AP MLD 310, the 802.1x controlled port for the current AP MLD 320 can be put in a blocked state. Thus, general data traffic cannot directly pass between the non-AP MLD 310 and the current AP MLD 320. This can be for both downlink and uplink directions.

According to one embodiment, when an execution/transition response frame (e.g., a link reconfiguration response frame for execution/transition phase) is transmitted by the current AP MLD 320, the 802.1x controlled port for the current AP MLD 320 can be kept in an unblocked state. Thus, general data traffic can directly pass between the non-AP MLD 310 and the current AP MLD 320 in the downlink direction. For the uplink direction, the data traffic can be blocked.

According to one embodiment, when an execution/transition response frame (e.g., a link reconfiguration response frame for execution/transition phase) is transmitted by the current AP MLD 320, the 802.1x controlled port for the current AP MLD 320 can be put in a blocked state. Thus, general data traffic cannot directly pass between the non-AP MLD 310 and the current AP MLD 320. This can be for both downlink and uplink directions.

According to one embodiment, the non-AP MLD can transmit a request message to the current AP MLD (e.g., in the link reconfiguration request frame for execution/transition phase) to request for blocking the 802.1x controlled port for the current AP MLD 320. The request message can be a field (e.g., a bit) that can take a predetermined value (e.g., 1) to make the indication and to another predetermined value (e.g., 0) to indicate otherwise.

According to one embodiment, the current AP MLD 320 can transmit an indication to the non-AP MLD 310 (e.g., in the link reconfiguration response frame for execution/transition phase) to inform the non-AP MLD 310 that the 802.1x controlled port for the current AP MLD 320 has been blocked/unblocked. The request message can be a field (e.g., a bit) that can take a predetermined value (e.g., 1) to make the indication and to another predetermined value (e.g., 0) to indicate otherwise.

According to one embodiment, the above behavior can be done when the link reconfiguration request frame for execution/transition arrives within a timeout value, and the target AP MLD 330 has been prepared for the non-AP MLD 310.

According to another embodiment, the above behavior can be done when the link reconfiguration request frame for execution/transition is received, and no prior preparation is done for the target AP MLD 330, but the links requested by the non-AP MLD 310 are accepted.

Thus, the 802.1x controlled port can be unblocked at least when the links requested by the non-AP MLD 310 either during the preparation phase that remains valid (e.g., as execution is performed within a timeout of the preparation phase) or the execution/transition phase in the link reconfiguration request frame are accepted.

According to one embodiment, when the non-AP MLD enters the transient phase (downlink draining phase) following the completion of the roam execution phase, the 802.1x controlled port for the current AP MLD can be blocked and for the target AP MLD can be in an unblocked state.

According to one embodiment, when the non-AP MLD enters the transient phase (downlink draining phase) following the completion of the roam execution phase, the 802.1x controlled port for the current AP MLD can be kept unblocked and for the target AP MLD can also be in an unblocked state. According to this embodiment, when the links at the current AP MLD are deleted, the 802.1x controlled port for the current AP MLD can be blocked.

According to one embodiment, when the target AP MLD receives a preparation request frame (e.g., a link reconfiguration request frame for preparation phase), the 802.1x controlled port for the target AP MLD can be unblocked. Thus, when the links at the target AP MLD are prepared through the target AP MLD, general data traffic can directly pass between the non-AP MLD and the target AP MLD.

According to one embodiment, when the target AP MLD transmits a preparation response frame (e.g., a link reconfiguration response frame for preparation phase), the 802.1x controlled port for the target AP MLD can be unblocked. Thus, when the links at the target AP MLD are prepared, general data traffic can directly pass between the non-AP MLD and the target AP MLD.

According to one embodiment, when the target AP MLD receives an execution request frame (e.g., a link reconfiguration request frame for execution phase), the 802.1x controlled port for the target AP MLD can be unblocked. Thus, when the execution phase is completed through the target AP MLD, general data traffic can directly pass between the non-AP MLD and the target AP MLD.

According to one embodiment, when the target AP MLD transmits an execution response frame (e.g., a link reconfiguration response frame for execution phase), the 802.1x controlled port for the target AP MLD can be unblocked. Thus, when the execution phase is completed through the target AP MLD, general data traffic can directly pass between the non-AP MLD and the target AP MLD.

According to one embodiment, when both the preparation and execution stages are completed in a single step with the target AP MLD, the 802.1x controlled port for the target AP MLD can be unblocked. Thus, when the preparation and execution stages are completed in a single step with the target PA MLD, general data traffic can directly pass between the non-AP MLD and the target AP MLD.

According to one embodiment, when a non-AP MLD associates with an AP MLD that is a part of a seamless roaming domain, the 802.1x uncontrolled ports at the other AP MLDs that are a part of the seamless roaming domain can be unblocked.

According to one embodiment, there can be a roam guarantee when a non-AP MLD roams from current AP MLD to a target AP MLD. The roam guarantee can be given to the non-AP MLD during the preparation/execution phase.

The roam guarantee can be given by including a roam guarantee message in one or more frames transmitted to the non-AP MLD as a part of the roaming procedure. E.g., response frames of preparation and/or execution phases such as the link reconfiguration response frame. The message an contain at least one or more of the information items as shown in Table 1.

TABLE 1
Information items that can be present in the roam guarantee message

| Information items | Description |
|---|---|
| Roam guarantee | One or more information items that can indicate a guaranteed roam. |
| indication | For example, a field (such as a bit) that can take a predetermined value |
| | (e.g., 1) to make the indication and to another value (e.g., 0) to indicate |
| | otherwise. |
| Guaranteed link | One or more information items that can indicate the links for which a |
| indication | roam guarantee can be provided. For example, a field (such as a bit) |
| | that can take a predetermined value (e.g., 1) to make the indication and |
| | to another predetermined value (e.g., 0) to indicate otherwise. The |
| | indication can be present in the per-STA profile field of the basic multi- |
| | link element in the link reconfiguration response frame. |
| Back link | One or more information items that can indicate backup links that can |
| indication | be used when the added links are no longer available. For example, |
| | back up link indication in the per-STA profile of the basic multi-link |
| | element in the link reconfiguration response frame. |

If the non-AP MLD is given a roam guarantee, then the link(s) at the target AP MLD cannot be deleted until the non-AP MLD has completed the roam phase.

According to one embodiment, when a non-AP MLD is given a roam guarantee, at least one of the prepared links at the target AP MLD can be available when the non-AP MLD roams to it.

According to another embodiment, if one or more of the links at the target AP MLD are deleted at the time the non-AP MLD roams from the current AP MLD to the target AP MLD, then the target AP MLD can provide a new set of link(s) to use upon roam to the target AP MLD. For example, if one or more links are added during the preparation phase and are deleted or scheduled to be deleted at the time of the execution phase, then the link reconfiguration response frame can contain a new list of link(s) to use upon roam to the target AP MLD. The new set of link(s) can be suitable for the non-AP MLD's needs.

According to another embodiment, when a non-AP MLD is given a roam guarantee, then the non-AP MLD can be given a set of back up links to use upon roam. If one or more of the prepared links are added during the preparation phase and get scheduled for deletion prior to the roam execution phase, then the non-AP MLD can make use of the backup links instead. The back up links can also be provided at the time of roam preparation phase.

According to one embodiment, a non-AP MLD can solicit a guaranteed roam. A non-AP MLD can transmit a guaranteed roam solicitation message to the current AP MLD. The message can contain at least one or more of the information items as shown in Table. 2.

TABLE 2
guaranteed roam solicitation message

| Information items | Description |
|---|---|
| Guaranteed roam | One or more information item(s) that can indicate a guaranteed roam |
| solicitation | solicitation. For example, a field (e.g., a bit) that can take a |
| indication | predetermined value (e.g., 1) to make the indication and to another |
| | predetermined value (e.g., 0) to indicate otherwise. |
| Link(s) indication | One or more information item(s) that can indicate the link(s) for |
| | which the guaranteed roam can be solicited. For example, link ID, |
| | link ID bitmap. There can also be a guaranteed roam solicitation |
| | indication in the per-STA profile in the reconfiguration ML element |
| | in the link reconfiguration request frame that can indicate the links for |
| | which a guaranteed roam can be solicited. |

Upon receiving the above message, the non-AP MLD can be provided with a response message which can contain at least one or more of the information items shown in Table 3.

TABLE 3
Information items that can be present in the response message

| Information items | Description |
|---|---|
| Guaranteed roam | One or more information item(s) that can indicate a guaranteed roam |
| assurance indication | assurance. For example, a field (e.g., a bit) that can take a |
| | predetermined value (e.g., 1) to make the indication and to another |
| | predetermined value (e.g., 0) to indicate otherwise. |
| Link(s) indication | One or more information item(s) that can indicate the link(s) for |
| | which the guaranteed roam can be assured. For example, link ID, |
| | link ID bitmap. There can also be a guaranteed roam assurance |
| | indication in the per-STA profile in the reconfiguration ML element |
| | in the link reconfiguration request frame that can indicate the links |
| | for which a guaranteed roam can be assured. |

According to one embodiment, a non-AP MLD can be given a guaranteed roam in an unsolicited manner. According to one embodiment, the non-AP MLD can be provided with a response message in Table 3 during the preparation/execution phases.

An AP MLD that can provide a roam guarantee can advertise the capability in one or more frames that it can transmit. For example, management frames such as beacons, probe responses, etc.

A non-AP MLD that can provide a roam guarantee can advertise the capability in one or more frames that it can transmit. For example, management frames such as probe requests, (re) association requests, etc.

According to one embodiment, the TSF synchronization with the reported AP MLD can occur through the current AP MLD. According to this embodiment, the current AP MLD can share an information message on the latest TSF timer of the reported AP MLD with the non-AP MLD. The information message can comprise at least one or more of the information items as shown in Table 4.

TABLE 4
Information items for the information message
on the latest TSF timer of the reported AP MLD

| Information items | Description |
|---|---|
| TSF timer related | One or more information items that can indicate the TSF timer at the |
| information | target AP. Examples of this information item can be as shown in Table |
| | 5. |
| Beacon interval | One or more information items that can indicate the beacon interval of |
| | the reported AP. |
| Link information | One or more information items that can indicate the link at the reported |
| | AP MLD that the information items in this table correspond to. E.g., |
| | link ID. |
| AP information | One or more information items that can indicate the AP at the reported |
| | AP MLD that the information items in this table correspond to. E.g., |
| | the AP MAC address. |
| TSF information | One or more information items that can indicate that the current AP |
| unavailability | MLD does not have any information on the TSF timer of the reported |
| indication | AP. |

TABLE 5
Information items for TSF timer related information

| Information items | Description |
|---|---|
| TSF timer | TSF timer value at the reported AP. The value can be set such that it |
| | is equal to the value of the reported AP's TSF timer at the time that |
| | the start of the data symbol containing the first bit of the frame |
| | (carrying this information item)/field (carrying this information) |
| | appears at the transmit antenna connector. |
| TSF offset | This can be the time difference between the TSF timer at the current |
| | AP and the reported AP. The offset can be given in modulo the |
| | reported AP's beacon interval and rounded to the nearest TU |
| | boundary. |
| TSF synchronization | An indication that the current AP and the reported AP have a TSF |
| indication | synchronization. This synchronization can either be in duration (i.e., a |
| | duration between two values of TSF timer at the current AP and the |
| | duration between the same two values of TSF timer at the reported AP |
| | are within a certain acceptable range (e.g., 30 us)) or can be in time |
| | (i.e., the TSF timer at the current AP and the reported AP are within a |
| | certain acceptable range (e.g., 30 us)). The indication can be provided |
| | via a field (e.g., a bit) that can take a predetermined value (e.g., 1) to |
| | make the indication and to another predetermined value (e.g., 0) to |
| | indicate otherwise. |

According to one embodiment, the TSF timer information can be provided for all the links of the reported AP MLD.

According to another embodiment, the TSF timer information can be provided for one of the links of the reported AP MLD which serves as a reference link and for other links of the reported AP MLD, an offset can be provided relative to the reference link.

The above information can be transmitted in an unsolicited manner or upon request from the non-AP as described below.

According to one embodiment, the non-AP can make a request for the TSF timer information of one or more APs of an AP MLD. This AP MLD can be a part of the same seamless roaming domain as the current AP MLD or can be in a different seamless roaming domain or may not be a part of any seamless roaming domain.

The non-AP can transmit a TSF request message to its current AP MLD. The TSF request message can contain at least one or more of the information items as shown in Table 6.

TABLE 6
Information items that can be present in a TSF request message

| Information items | Description |
|---|---|
| AP MLD identifier | One or more information items that can identify an AP MLD whose |
| | AP's TSF timer can be requested. For example, an AP MLD MAC |
| | address, BSSID, etc. |
| AP identifier | One or more information items that can identify an AP affiliated with |
| | the above indicated AP MLD. For example, AP MAC address, etc. |
| Link indication | One or more information items that can identify links whose TSF |
| | timer information can be requested. For example, link ID, link ID |
| | bitmap. |
| TSF timer | One or more information items that can indicate that a TSF timer |
| information request | information can be requested. For example, a field (such as a bit) that |
| indication | can take a predetermined value (e.g., 1) to make the indication and to |
| | another predetermined value (e.g., 0) to indicate otherwise. |

Upon receiving the above request, the current AP can collect the necessary information and provide it to the non-AP.

According to one embodiment, the current AP MLD can obtain information about the TSF timer of the APs of the AP MLDs in its seamless roaming domain (e.g., seamless mobility domain). This information can either be obtained by direct communication with the AP MLDs or via the controller.

The current AP MLD can update the information regularly as needed.

The current AP MLD can provide the TSF information value such that it is equal to the value of the reported AP's TSF timer at the time that the start of the data symbol containing the first bit of the frame (carrying this information item)/field (carrying this information) appears at the transmit antenna connector.

According to one embodiment, the non-AP STA can update the TSF timer as per the information provided by the current AP MLD. This can be done when transitioning to the target AP MLD. For example, at the end of the transient phase following the roaming execution phase, after the links at the current AP MLD have been deleted, downlink buffer at the current AP MLD has been exhausted, etc.

When setting the value provided by the current AP MLD, the non-AP can compensate for delays along the transmit path. For example, delays through the local PHY from the MAC-PHY interface to the transmit antenna connector.

There can be a transient phase following the roaming execution phase. During the roaming execution phase, the non-AP MLD can be retrieving frames from the current AP MLD.

According to one embodiment, when the non-AP MLD retrieves all the frames possible from the current AP MLD before transitioning to the target AP MLD, the non-AP MLD can continue to use the TSF timer for various connected links. After transitioning, the non-AP MLD can start using the TSF timer of the target AP MLD.

In some cases, the non-AP MLD can also fetch frames from the current AP MLD and the target AP MLD at the same time. In such a situation, the non-AP MLD can switch from the TSF timer of the current AP MLD to the target AP MLD and back depending on the AP MLD with which it is communicating.

According to one embodiment, the non-AP MLD can maintain the TSF timer of one or more links of the current AP MLD on one or more links that it can use to communicate with the current AP MLD and the TSF timer of one or more links of the target AP MLD on one or more links that it can use to communicate with the target AP MLD.

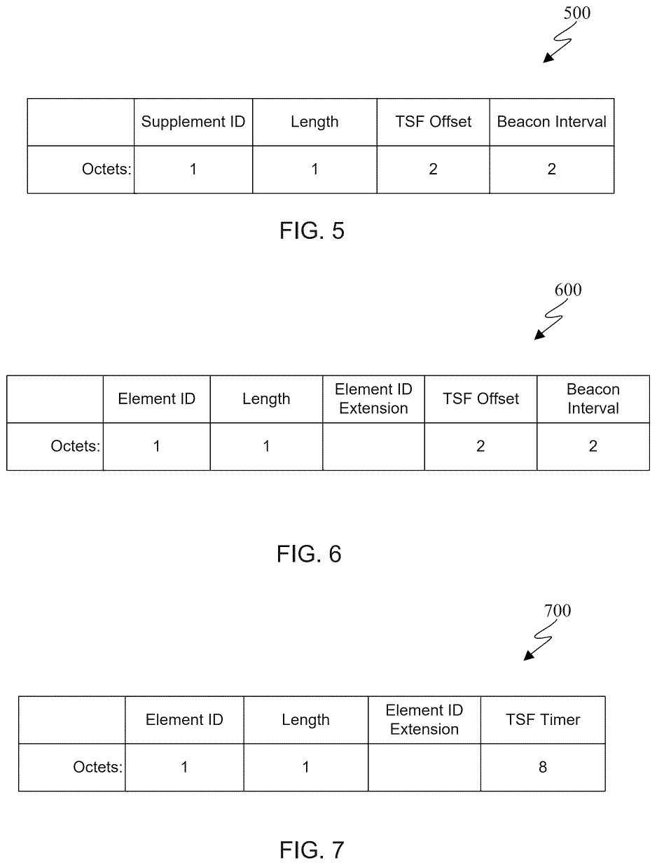

FIG. 5 illustrates an example TSF sub-element format 500 according to embodiments of the present disclosure. The embodiment of an example TSF sub-element format of FIG. 5 is for illustration only. Different embodiments of an example TSF sub-element format could be used without departing from the scope of this disclosure.

According to one embodiment, the TSF timer information can be carried in the basic multi-link element.

According to one embodiment, the per-STA profile of the basic multi-link element can carry a TSF sub-element as one of the sub-elements. The per-STA profile that carries this sub-element can be corresponding to the link of the reported neighbor AP MLD.

The TSF offset can contain a TSF offset for an AP affiliated with an AP MLD that is in the same seamless roaming domain as the reporting AP MLD. This can be the timing difference between the reporting AP and the reported AP's TSF timers. The time difference can be in TUs or in microseconds. The offset can also be given module the reported AP's beacon interval and rounded to the nearest TU boundary.

The beacon interval field can carry the beacon interval of the AP affiliated with an AP MLD that is in the same seamless roaming domain as the reporting AP MLD.

According to one embodiment, the basic multilink element carrying such a TSF sub-element can be transmitted by an AP affiliated with an AP MLD that is in the same seamless roaming domain as the reported AP MLD. There can be an indication in the basic multi-link element or the frame carrying the basic multi-link element that the AP affiliated with the reporting AP MLD belongs to the same seamless roaming domain as the reported AP MLD.

According to one embodiment, the basic multilink element carrying such a TSF sub-element can be transmitted by an AP that is a part of a different seamless roaming domain than the reported AP MLD. There can be an indication in the basic multi-link element or the frame carrying the basic multi-link element that the AP affiliated with the reporting AP MLD belongs to a different seamless roaming domain than the reported AP MLD.

According to one embodiment, the basic multilink element carrying such a TSF sub-element can be transmitted by an AP that is a part of a different seamless roaming domain than the reported AP MLD but a part of the same FT mobility domain as the reported AP MLD. There can be an indication in the basic multi-link element or the frame carrying the basic multi-link element that the AP affiliated with the reporting AP MLD belongs to a different seamless roaming domain than the reported AP MLD but the same FT domain as the reported AP MLD.

FIG. 6 illustrates an example TSF element format 600 according to embodiments of the present disclosure. The embodiment of an example TSF element format of FIG. 6 is for illustration only. Different embodiments of an example TSF element format could be used without departing from the scope of this disclosure.

According to one embodiment, there can be a TSF element that can carry this information. The TSF element can have an example format as shown in FIG. 6.

The content of the TSF offset and the beacon interval can have the same description as described herein.

FIG. 7 illustrates another example TSF element format 700 according to embodiments of the present disclosure. The embodiment of an example TSF element format of FIG. 7 is for illustration only. Different embodiments of an example TSF element format could be used without departing from the scope of this disclosure.

The TSF timer can be equal to the value of the reported AP's TSF timer at the time that the start of the data symbol containing the first bit of the frame (carrying this information item)/field (carrying this information) appears at the transmit antenna connector.

According to one embodiment, instead of the complete TSF timer, this can also be a partial TSF timer. For example, a few bits of the TSF timer, the pentapartial TSF timer, tetrapartial TSF timer, etc.

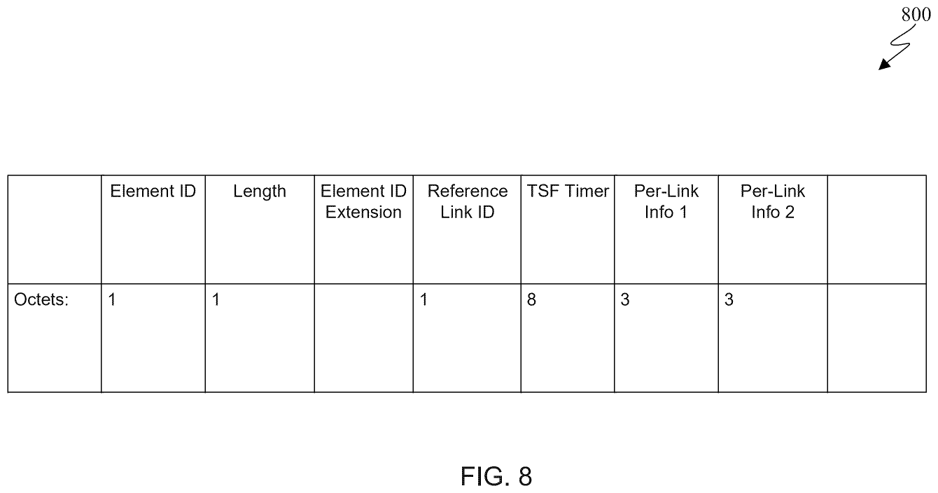

FIG. 8 illustrates yet another example TSF element format 800 according to embodiments of the present disclosure. The embodiment of an example TSF element format of FIG. 8 is for illustration only. Different embodiments of an example TSF element format could be used without departing from the scope of this disclosure.

In one embodiment, the reference link ID can be the link ID of the reference link.

In one embodiment, the TSF timer can be the timer of the reference link.

In one embodiment, the per-link info can be TSF information for all the other links relative to the TSF timer of the reference link.

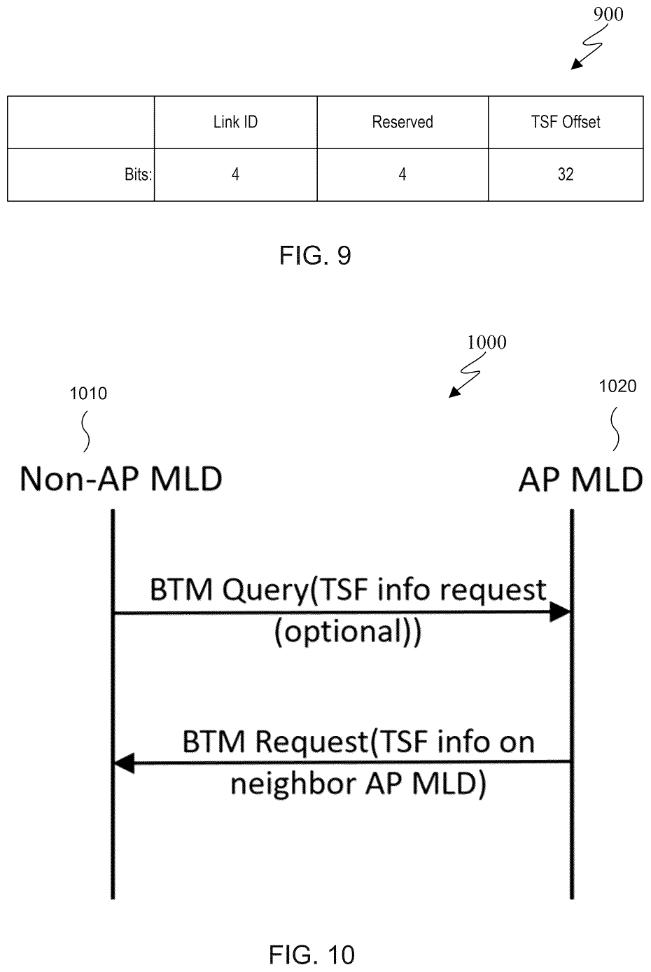

FIG. 9 illustrates an example per-link information field format 900 according to embodiments of the present disclosure. The embodiment of an example per-link information field format of FIG. 9 is for illustration only. Different embodiments of an example per-link information field format could be used without departing from the scope of this disclosure.

In one embodiment, the per-link info can carry the TSF information of the remaining links of the same reported AP MLD relative to the reference link indicated by the reference link ID in the TSF element. An example format can be as shown in FIG. 9.

The link ID can be the link ID of another link of the reported AP MLD.

The TSF offset can be relative to the reference link's TSF timer indicated in the TSF element.

According to one embodiment, this information can be present in the SMD element.

According to one embodiment, the TSF information can be carried in a link reconfiguration response frame that is sent at the time of seamless roaming preparation phase or seamless roaming execution phase.

The format of the modified link reconfiguration response frame can be as shown in Table 7. There can be an element/sub-element that can carry the TSF information.

TABLE 7
Modified link reconfiguration response frame

| Order | Meaning |
|---|---|
| 1 | Category |
| 2 | Protected EHT Action |
| 3 | Dialog Token |
| 4 | Count |
| 5 | Reconfiguration Status List |
| 6 | Group Key Data |
| 7 | OCI element |
| 8 | Basic ML element |
| 9 | Element/sub-element |
| | carrying TSF information |

According to another embodiment, the information can be present in the Basic ML element. For example, in the per-STA profile of the basic ML element.

The non-AP MLD can make a request for this information in a modified link reconfiguration request frame. The modified link reconfiguration request frame can have a format as shown in Table 8.

TABLE 8
Modified link reconfiguration request frame

| Order | Meaning |
|---|---|
| 1 | Category |
| 2 | Protected EHT Action |
| 3 | Dialog Token |
| 4 | Reconfiguration ML element |
| 5 | OCI element |
| 6 | Element/sub-element carrying a |
| | request for TSF information |

According to one embodiment, the request for TSF information can be present in an element/sub-element. For example, a bit that can take a predetermined value (e.g., 1) to indicate a request and to another value (e.g., 0) to indicate otherwise.

According to another embodiment, the request for TSF information can be present in the reconfiguration ML element. For example, a bit that can take a predetermined value (e.g., 1) to indicate a request and to another value (e.g., 0) to indicate otherwise.

According to one embodiment, the TSF timer information can be carried inside a neighbor report in the BTM request frame. For instance, there can be a basic ML element which can carry the TSF sub-element for each of the links in the per-STA profile.

The request for TSF information can be made by the non-AP in the BTM query frame. According to another embodiment, the request may not be made, and the information can be provided in the request frame in an unsolicited manner.

FIG. 10 illustrates an example candidate selection procedure with TSF information sharing 1000 according to embodiments of the present disclosure. The embodiment of an example candidate selection procedure with TSF information sharing of FIG. 10 is for illustration only. Different embodiments of an example candidate selection procedure with TSF information sharing could be used without departing from the scope of this disclosure.

According to one embodiment, the TSF information can be advertised by a reporting AP MLD in management frames such as beacons, probe responses, (re) association responses, etc. as a part of the roaming discovery procedure.

According to one embodiment, the TSF information can be provided during a candidate AP selection procedure as shown in FIG. 10. For example, when the AP MLD 1020 receives a BTM Query from the non-AP MLD 1010, the AP MLD 1020 can send a BTM Request that includes TSF information on a neighbor AP MLD to the non-AP MLD 1010.

According to another embodiment, the TSF info request may not be present in the BTM query.

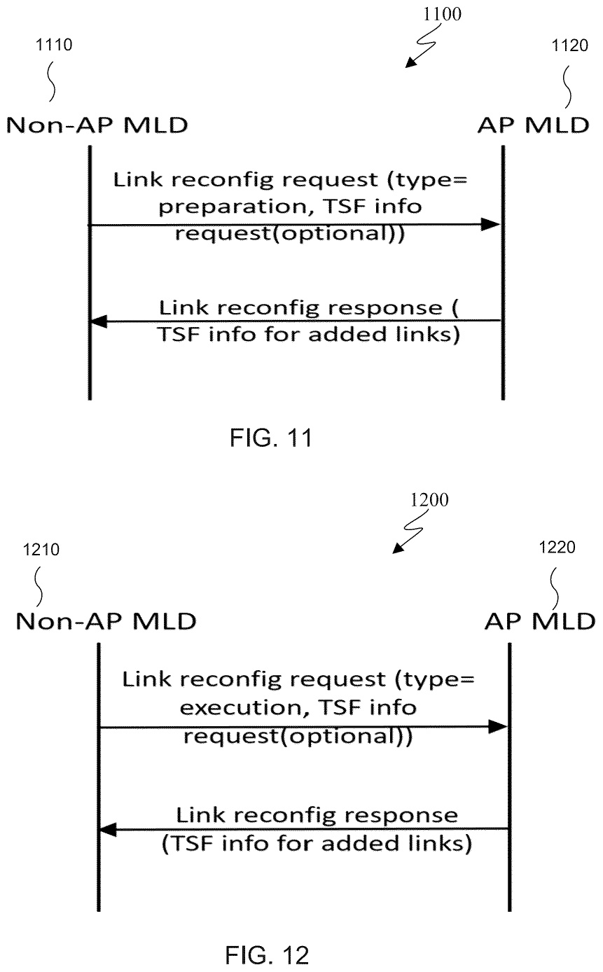

FIG. 11 illustrates an example of TSF sharing during a preparation phase 1100 according to embodiments of the present disclosure. The embodiment of an example of TSF sharing during a preparation phase of FIG. 11 is for illustration only. Different embodiments of an example of TSF sharing during a preparation phase could be used without departing from the scope of this disclosure.

According to one embodiment, the TSF information can be requested during the preparation phase as shown in FIG. 11. For example, when the AP MLD 1120 receives a link reconfiguration request from the non-AP MLD 1110, the AP MLD 1120 can send a link reconfiguration response that includes TSF information for added links to the non-AP MLD 1110.

According to another embodiment, the TSF information can be provided without a request in an unsolicited manner during the preparation phase.

FIG. 12 illustrates an example of TSF sharing during an execution phase 1200 according to embodiments of the present disclosure. The embodiment of an example of TSF sharing during an execution phase of FIG. 12 is for illustration only. Different embodiments of an example of TSF sharing during an execution phase could be used without departing from the scope of this disclosure.

According to one embodiment, the TSF information can be requested during the execution phase as shown in FIG. 12. For example, when the AP MLD 1220 receives a link reconfiguration request from the non-AP MLD 1210, the AP MLD 1220 can send a link reconfiguration response that includes TSF information for added links to the non-AP MLD 1210.

According to another embodiment, the TSF information can be provided without a request in an unsolicited manner during the preparation phase.

According to one embodiment, the AP MLDs in the examples described with respect to FIGS. 11 and 12 can be the current AP MLD.

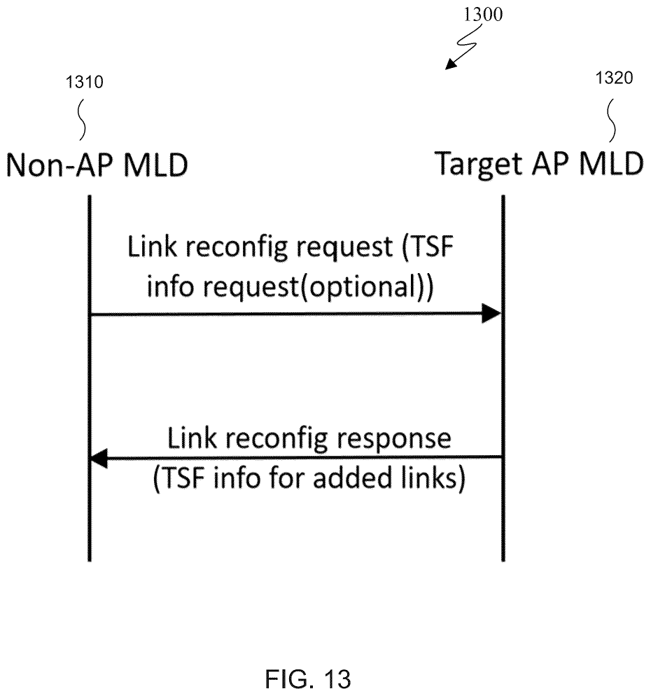

FIG. 13 illustrates an example of TSF sharing through the target AP MLD 1300 according to embodiments of the present disclosure. The embodiment of an example of TSF sharing through the target AP MLD of FIG. 13 is for illustration only. Different embodiments of an example of TSF sharing through the target AP MLD could be used without departing from the scope of this disclosure.

According to one embodiment, the TSF information can be obtained through the target AP MLD 1320 as shown in FIG. 13. For example, when the target AP MLD 1320 receives a link reconfiguration request from the non-AP MLD 1310, the target AP MLD 1320 can send a link reconfiguration response that includes TSF information for added links to the non-AP MLD 1310.

In one embodiment, the reporting AP MLD can be an AP MLD that reports the TSF timer of another AP MLD.

In one embodiment, the reporting AP can be an AP affiliated with the reporting AP MLD. This can also be the AP that is affiliated with the reporting AP MLD and that transmits the TSF information.

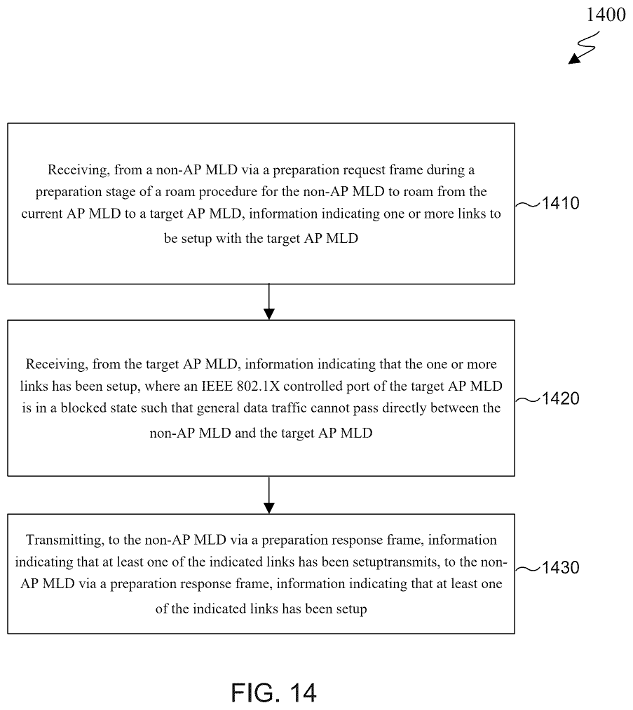

FIG. 14 illustrates an example method 1800 performed by a current access point (AP) multi-link device (MLD) in a wireless communication system according to embodiments of the present disclosure. The method 1400 of FIG. 14 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 1400 is for illustration only and other embodiments can be used without departing from the scope of the present disclosure.

As illustrated in FIG. 14, the method 1400 begins at step 1410, where the current AP MLD receives, from a non-AP MLD via a preparation request frame during a preparation stage of a roam procedure for the non-AP MLD to roam from the current AP MLD to a target AP MLD, information indicating one or more links to be setup with the target AP MLD. At step 1420, the current AP MLD receives, from the target AP MLD, information indicating that the one or more links has been setup, where an IEEE 802.1X controlled port of the target AP MLD is in a blocked state such that general data traffic cannot pass directly between the non-AP MLD and the target AP MLD. At step 1430, the current AP MLD transmits, to the non-AP MLD via a preparation response frame, information indicating that at least one of the indicated links has been setup.

In some embodiments, the current AP MLD, during an execution stage of the roam procedure, receives, from the non-AP MLD via an execution request frame, an execution request; receives, from the target AP MLD, a response to the execution request indicating acceptance of the execution request, wherein the IEEE 802.1X controlled port of the target AP MLD is in an unblocked state such that general data traffic can pass directly between the non-AP MLD and the target AP MLD; and transmits, to the non-AP MLD via an execution response frame, the response to the execution request received from the target AP MLD.

In some embodiments, the preparation stage and the execution stage are completed in a single step.

In some embodiments, an IEEE 802.1X controlled port of the current AP MLD is in an unblocked state for general data traffic passage in a downlink direction such that general data traffic can pass directly between the non-AP MLD and the current AP MLD in the downlink direction and in a blocked state for general data traffic passage in an uplink direction such that general data traffic cannot pass directly between the non-AP MLD and the current AP MLD in the uplink direction.

In some embodiments, after completion of the execution stage of the roam procedure and for a duration of time comprising a downlink draining period which includes an amount of time needed to drain a downlink buffer of the current AP MLD, an IEEE 802.1X controlled port of the current AP MLD is in an unblocked state for general data traffic passage such that general data traffic can pass directly between the non-AP MLD and the current AP.

In some embodiments, when links between the non-AP MLD and the current AP MLD are deleted, the IEEE 802.1X controlled port of the current AP MLD is in a blocked state for general data traffic passage such that general data traffic cannot pass directly between the non-AP MLD and the current AP.

In some embodiments, an IEEE 802.1X uncontrolled port of the current AP MLD is in an unblocked state for data traffic passage such that data traffic can pass directly between the non-AP MLD and the current AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a current access point (AP) multi-link device (MLD), the method comprising:
receiving, from a non-AP MLD via a preparation request frame during a preparation stage of a roam procedure for the non-AP MLD to roam from the current AP MLD to a target AP MLD, information indicating one or more links to be setup with the target AP MLD;
receiving, from the target AP MLD, information indicating that the one or more links has been setup, wherein an IEEE 802.1X controlled port of the target AP MLD is in a blocked state such that general data traffic cannot pass directly between the non-AP MLD and the target AP MLD; and
transmitting, to the non-AP MLD via a preparation response frame, information indicating that at least one of the indicated links has been setup.

2. The method of claim 1, further comprising, during an execution stage of the roam procedure:
receiving, from the non-AP MLD via an execution request frame, an execution request;
receiving, from the target AP MLD, a response to the execution request indicating acceptance of the execution request, wherein the IEEE 802.1X controlled port of the target AP MLD is in an unblocked state such that general data traffic can pass directly between the non-AP MLD and the target AP MLD; and
transmitting, to the non-AP MLD via an execution response frame, the response to the execution request received from the target AP MLD.

3. The method of claim 2, wherein the preparation stage and the execution stage are completed in a single step.

4. The method of claim 2, wherein an IEEE 802.1X controlled port of the current AP MLD is in an unblocked state for general data traffic passage in a downlink direction such that general data traffic can pass directly between the non-AP MLD and the current AP MLD in the downlink direction and in a blocked state for general data traffic passage in an uplink direction such that general data traffic cannot pass directly between the non-AP MLD and the current AP MLD in the uplink direction.

5. The method of claim 2, wherein after completion of the execution stage of the roam procedure and for a duration of time comprising a downlink draining period which includes an amount of time needed to drain a downlink buffer of the current AP MLD, an IEEE 802.1X controlled port of the current AP MLD is in an unblocked state for general data traffic passage such that general data traffic can pass directly between the non-AP MLD and the current AP.

6. The method of claim 5, wherein when links between the non-AP MLD and the current AP MLD are deleted, the IEEE 802.1X controlled port of the current AP MLD is in a blocked state for general data traffic passage such that general data traffic cannot pass directly between the non-AP MLD and the current AP.

7. The method of claim 1, wherein an IEEE 802.1X uncontrolled port of the current AP MLD is in an unblocked state for data traffic passage such that data traffic can pass directly between the non-AP MLD and the current AP.

8. A method performed by a target access point (AP) multi-link device (MLD), the method comprising:
receiving, from a current AP MLD during a preparation stage of a roam procedure for a non-AP MLD to roam from the current AP MLD to the target AP MLD, information indicating one or more links to be setup with the target AP MLD;
transmitting, to the current AP MLD, information indicating that the one or more links has been setup, wherein an IEEE 802.1X controlled port of the target AP MLD is in a blocked state such that general data traffic cannot pass directly between the non-AP MLD and the target AP MLD; and
transmitting, to the current AP MLD, information indicating that at least one of the indicated links has been setup.

9. The method of claim 8, further comprising, during an execution stage of the roam procedure:
receiving, from the current AP MLD, information indicating an execution request; and
transmitting, to the non-AP MLD via the current AP MLD, a response to the execution request indicating acceptance of the execution request, wherein the IEEE 802.1X controlled port of the target AP MLD is in an unblocked state such that general data traffic can pass directly between the non-AP MLD and the target AP MLD.

10. The method of claim 9, wherein after completion of the execution stage of the roam procedure, the IEEE 802.1X controlled port of the target AP MLD is in the unblocked state for general data traffic passage such that general data traffic can pass directly between the non-AP MLD and the current AP.

11. The method of claim 9, wherein when the preparation stage and the execution stage are completed in a single step, the IEEE 802.1X controlled port of the target AP MLD is in an unblocked state such that general data traffic can pass directly between the non-AP MLD and the target AP MLD.

12. The method of claim 8, further comprising, during an execution stage of the roam procedure:
receiving, from the non-AP MLD via an execution request frame, an execution request; and
transmitting, to the non-AP MLD via an execution response frame, a response to the execution request indicating acceptance of the execution request, wherein the IEEE 802.1X controlled port of the target AP MLD is in an unblocked state such that general data traffic can pass directly between the non-AP MLD and the target AP MLD.

13. The method of claim 12, wherein after completion of the execution stage of the roam procedure, the IEEE 802.1X controlled port of the target AP MLD is in the unblocked state for general data traffic passage such that general data traffic can pass directly between the non-AP MLD and the current AP.

14. The method of claim 12, wherein when the preparation stage and the execution stage are completed in a single step, the IEEE 802.1X controlled port of the target AP MLD is in an unblocked state such that general data traffic can pass directly between the non-AP MLD and the target AP MLD.

15. A method performed by a non-access point (AP) multi-link device (MLD), the method comprising:
transmitting, to a current AP MLD via a preparation request frame during a preparation stage of a roam procedure for the non-AP MLD to roam from the current AP MLD to a target AP MLD, information indicating one or more links to be setup with the target AP MLD; and
receiving, from the current AP MLD via a preparation response frame, information indicating that at least one of the one or more indicated links has been setup, wherein an IEEE 802.1X controlled port of the target AP MLD is in a blocked state such that general data traffic cannot pass directly between the non-AP MLD and the target AP MLD.

16. The method of claim 15, further comprising, during an execution stage of the roam procedure:
transmitting, to the current AP MLD via an execution request frame, information indicating an execution request; and
receiving, from the current AP MLD via an execution response frame, a response to the execution request indicating acceptance of the execution request, wherein the IEEE 802.1X controlled port of the target AP MLD is in an unblocked state such that general data traffic can pass directly between the non-AP MLD and the target AP MLD.

17. The method of claim 16, wherein after completion of the execution stage of the roam procedure, the IEEE 802.1X controlled port of the target AP MLD is in the unblocked state for general data traffic passage such that general data traffic can pass directly between the non-AP MLD and the target AP.

18. The method of claim 15, further comprising, during an execution stage of the roam procedure:
transmitting, to the target AP MLD via an execution request frame, information indicating an execution request; and
receiving, from the target AP MLD, a response to the execution request indicating acceptance of the execution request, wherein the IEEE 802.1X controlled port of the target AP MLD is in an unblocked state such that general data traffic can pass directly between the non-AP MLD and the target AP MLD.

19. The method of claim 18, wherein after completion of the execution stage of the roam procedure, the IEEE 802.1X controlled port of the target AP MLD is in the unblocked state for general data traffic passage such that general data traffic can pass directly between the non-AP MLD and the current AP.

20. The method of claim 18, wherein after completion of the execution stage of the roam procedure and for a duration of time comprising a downlink draining period which includes an amount of time needed to drain a downlink buffer of the current AP MLD, an IEEE 802.1X controlled port of the current AP MLD is in an unblocked state for general data traffic passage such that general data traffic can pass directly between the non-AP MLD and the current AP, and the IEEE 802.1X controlled port of the target AP MLD is in an unblocked state for general data traffic passage such that general data traffic can pass directly between the non-AP MLD and the target AP.
